(19) United States
(12) Patent Application Publication
(10) Pub. No.: US 2010/0209804 A1
(43) Pub. Date: Aug. 19, 2010

(54) Carbon-supported Tantalum Oxide Nanocomposites and Methods of Making the Same

(75) Inventors: Yongsoon Shin, Richland, WA (US); Jin Yong Kim, Richland, WA (US); Kenneth S. Weil, Richland, WA (US); Jeff F. Bonnett, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 12/372,511

(22) Filed: Feb. 17, 2009

(51) Int. Cl. H01M 4/00; H01M 4/88

(52) U.S. Cl. 429/483; 502/101; 429/488

(57) ABSTRACT

The present invention includes hybrid nanocomposite catalysts having tantalum oxide nanoparticles covalently bound to a functionalized carbon support and methods of making the same. The methods include functionalizing the carbon support surfaces, dispersing the functionalized carbon support in an organic liquid, and adding a ta-containing metalorganic precursor. The metalorganic precursor has an alkoxide group that reacts with the functional groups on the carbon support surface. The organic liquid is removed and the resultant material has properties that make it a suitable catalyst, especially in polymer-electrolyte-membrane fuel cell applications.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

Polymer electrolyte membrane (PEM) fuel cells offer great promise as a clean source of power, and are therefore the subject of great interest. PEM fuel cells utilize high purity hydrogen as a source fuel, which can be catalyzed at the anode and stripped of its electrons. The electrons travel under a potential across an electrical load, where they generate power while the resulting protons are transported down a chemical gradient across a polymer electrolyte to the cathode. At the cathode, incoming oxygen combines with the electrons and the transported protons to form water and heat. In conventional PEM fuel cells, platinum is employed as a catalyst in the electrodes, and contributes significantly to the overall cost of a PEM fuel cell stack. Accordingly, considerable amounts of research have been expended in efforts to reduce the platinum loading while minimizing the effects on stack performance. However, the cost of the platinum currently needed for acceptable stack performance is one of the primary bottlenecks to the commercialization of PEM fuel cells beyond niche applications. Therefore, a need exists for alternative catalysts to replace expensive platinum-based catalysts in PEM fuel cells and in other applications requiring similar catalytic functions.

### SUMMARY

The present invention includes a hybrid nanocomposite catalyst comprising tantalum oxide nanoparticles on a carbon support that can replace expensive platinum-based catalysts used in traditional PEM fuel cells. Outside of the present invention, the use of tantalum oxide as a PEM catalyst is very limited due to its poor electrical conductivity, which limits catalytic reaction sites and hence the reduction current, even though it has a high oxygen reduction reaction (ORR) potential that is comparable to platinum. Embodiments of the present invention can increase the reaction sites and hence the current density by maximizing the triple-phase boundaries between the tantalum oxide, the current collecting support, and the aqueous electrolyte. The size of the tantalum oxide and the nature of the bonding to the support can have significant impacts on maximizing such triple-phase boundaries. The synthesis of nanoscale tantalum oxide particles on the carbon support can increase the line density of the triple-phase boundaries, thereby increasing the reduction current density of tantalum oxide catalysts. Accordingly, the present invention also includes methods of synthesizing the carbon-supported tantalum oxide hybrid nanocomposites.

In one embodiment of the present invention, which is depicted in FIG. 1, the method for fabricating the carbon-supported tantalum oxide nanoparticles comprises attaching organic functional groups to the surfaces of a carbon material, which results in a functionalized carbon support. The functionalized carbon support can then be dispersed in an organic liquid to which is added a tantalum-containing metal organic precursor. The tantalum-containing metal organic precursor should comprise an alkoxide group. The mixture of the three components provides a medium for reacting the alkoxide groups of the tantalum-containing metal organic precursor with the functional groups on the surface of the functionalized carbon support, which reaction forms a covalent bond between tantalum oxide nanoparticles and the carbon support.

In preferred embodiments the functional group comprises a carboxyl, a carbonyl, or a hydroxyl group. The tantalum-containing metal organic precursor can comprise tantalum ethoxide. An example of an organic liquid includes, but is not limited to, ethanol. In a particular implementation the tantalum-containing metal organic precursor can be five percent to seventy-five percent by weight of the mixture. In another example of the mixture composition, the volumetric ratio of the tantalum-containing metal organic precursor to the organic liquid can be between 1:30 and 1:15.

Some embodiments of the present invention can further comprise making a complex of the tantalum-containing metal organic precursor prior to forming the mixture with the functionalized carbon support and the organic liquid. An exemplary complex is one between tantalum ethoxide and 2,4-acetylacetonate. A particular example of the reaction that can occur between the tantalum-containing metal organic precursor and the functional groups on the surface of the carbon material can include, but is not limited to, hydrolysis and condensation.

In preferred embodiments the tantalum oxide nanoparticles comprise Ta₂O₅. In order to maximize the triple point boundaries, the tantalum oxide nanoparticles can have diameters less than one micron. Further still, the tantalum oxide nanoparticles can have diameters that are less than or equal to one hundred nm.

In some embodiments of the present invention, no surfactant is added to the mixture.

Another aspect of the present invention is a catalyst for PEM fuel cells, wherein the catalyst comprises tantalum oxide nanoparticles that are covalently attached to the carbon support. The tantalum oxide nanoparticles can comprise Ta₂O₅. The nanoparticles can have diameters that are less than one micron, and preferably that are less than or equal to 100 nm. The covalent bonding and the limited particle size is aided by the organic solvent, which appears to slow oxidation of the precursor. Furthermore, in preferred embodiments, the synthesis is not performed at elevated temperatures. For example, the synthesis can be performed at room temperature without an additional heat source.

The catalysts of the present invention can have mass specific reduction currents that are greater than two percent of the mass specific reduction current of platinum. Alternatively, or in addition, the catalysts of the present invention can have an area-specific reduction current greater than 30 percent of the area-specific reduction current of platinum.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a block diagram depicting a method of fabricating a carbon-supported tantalum oxide nanocomposite according to embodiments of the present invention.

FIG. 2 is an illustration the surface of functionalized carbon supports according to embodiments of the present invention.

FIG. 3 includes XRD and FT-IR results from functionalized and non-functionalized carbon materials.

FIG. 4 includes FT-IR spectra of carbon-supported tantalum oxide nanocomposites as synthesized according to embodiments of the present invention.

FIG. 5 includes SEM micrographs of carbon-supported tantalum oxide nanomaterials.

FIG. 6 is a graph of the oxygen reduction potential as a function of temperature for a number of materials.

FIG. 7 is a bar graph of the mass specific current density for a number of materials.

FIG. 8 is a bar graph of the area specific current density for a number of materials.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In one example, Ta₂O₅ nanoparticles were synthesized on carbon supports using tantalum ethoxide [Ta(OEt)₅], thionyl chloride (SOCl₂) carbon nanoparticles (approx. 30 nm) as starting materials. The carbon nanoparticles were first treated to functionalize the surfaces. Referring to FIG. 2, the as-received carbon nanoparticles 201 were dispersed in a mixture of concentrated nitric acid and sulfuric acid (5:3 vol ratio) and refluxed for 1 h. The sample was repeatedly washed with deionized water until the solution reached a pH value of 7. The filtered carbon solid was dried under vacuum for 24 h at 70° C. Dried carboxylate-functionalized carbon 202 was suspended in SOCl₂ and stirred for 24 h at 70° C. The solution was filtered, washed with anhydrous THF, and dried under vacuum at room temperature 203.

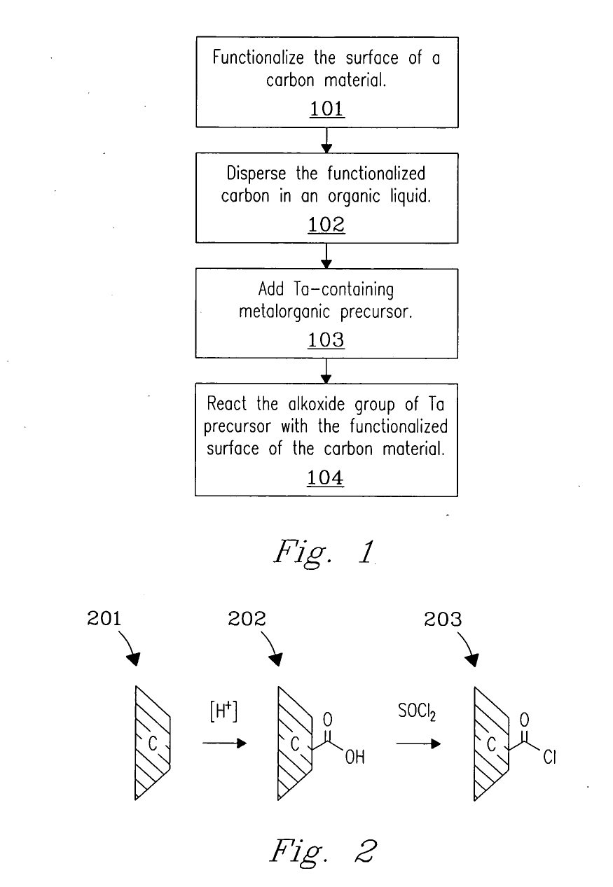

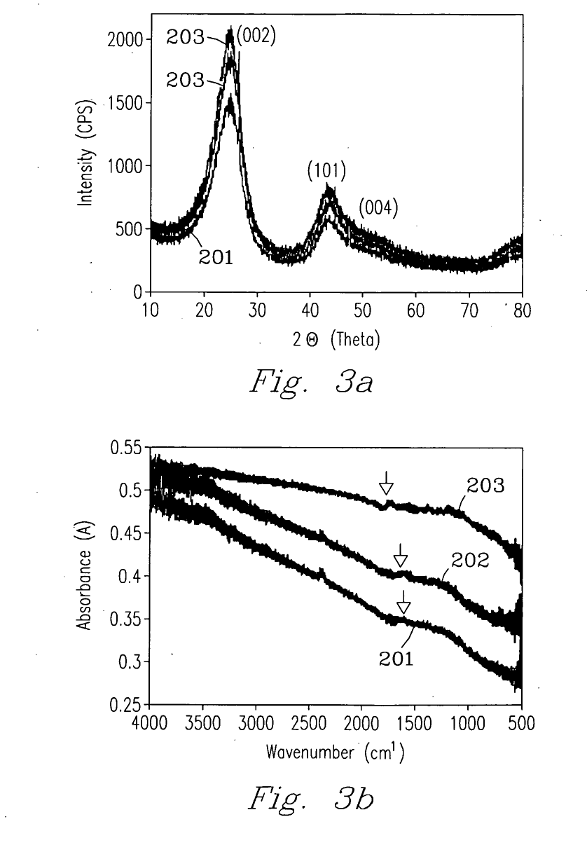

The functionalized carbon materials described above were characterized by X-ray diffraction (XRD) and FT-IR spectroscopy as shown in FIGS. 3a and 3b, respectively. The as-received carbon material 201 showed semi-crystalline structure and the two broad reflections at 2θ=26.56° and 44.61°, which are attributed to (002) and (101) diffractions. The (004) diffraction peak at 54.74° is very weak. Two absorption bands at 3400 and 1682 cm⁻¹ are noted as belonging to —OH and carbonyl (C═O) groups in the FT-IR spectrograph for the as-received carbon 201. After acid treatment, carbon sample 202 showed the same absorption peaks. However, after acylation process, the C═O stretching vibration was shifted to 1720 cm⁻¹ due to the formation of chlorocarbonyl (COCl) groups on the 203 surface (FIG. 1b).

For direct synthesis of Ta₂O₅ on carbon supports, to 2.0 g of either 201 or surface modified carbons (202 or 203) dispersed in 20 mL of ethanol, different amounts of Ta(OEt)₅ (8, 4, 2, or 1 g) were added, and stirred overnight at room temperature. The reactive Ta(OEt)₅ slowly hydrolyzes to form tantalum oxide, while the ethanol can slow the oxidation of the Ta(OEt)₅ on the carbon surface. The remaining ethanol was eliminated at 60° C. under vacuum overnight. Each sample was ball-milled for 15 minutes.

Attempted synthesis of nanocrystalline mesoporous Ta₂O₅ through a dodecylamine (DDA)-assisted sol-gel process, which is known in the art, was not successful. The crystalline β-Ta₂O₅ formation temperature of amorphous Ta₂O₅ is 625° C. However, attempts to reach this temperature caused the mesoporous network to begin collapsing at 400° C. and to completely collapse at 500° C. The collapse appeared to be due to large particle growth through agglomeration. Because of the large particle size and agglomeration during these high temperature growth attempts, the resultant pores exist mainly between the particles, and the available surface area (40-80 m2/g) was unacceptably low.

On the other hand, synthesis according to embodiments of the present invention produced sub-micron sized tantalum oxide particles on carbon supports. For example, direct reaction between functionalized carbon and Ta(OEt)₅ followed by controlled hydrolysis according to methods described herein, leads to a dispersion of sub-micron sized Ta₂O₅ particles on the carbon surface. The Ta₂O₅ was synthesized by slowly reacting Ta(OEt)₅ with functionalized carbon dispersed in EtOH. Through slow evaporation of the EtOH solvent, Ta(OEt)₅ hydrolyzes and condenses to form well-dispersed sub-micron Ta₂O₅ particles on the carbon support. The reaction is believed to proceed according to Eqn. 1. The remaining solvent adsorbed on the carbon support was eliminated by vacuum drying.

2Ta(OCH₂CH₃)₅+5H₂O→Ta₂O₅+10HOCH₂CH₃ Eqn. 1

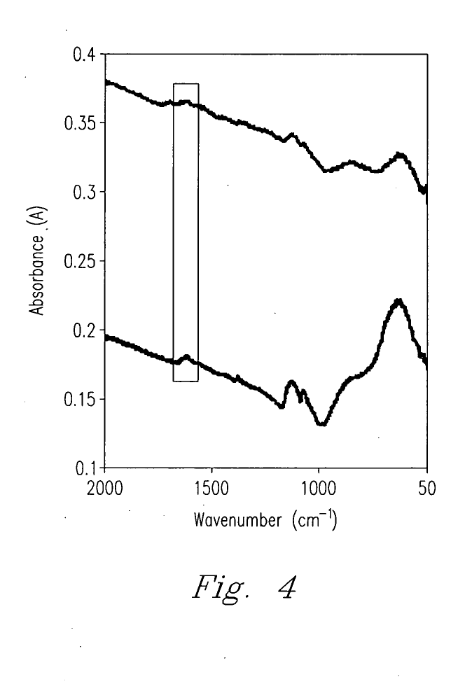

Referring to FIG. 4, a graph shows the FT-IR spectrograph for two samples of Ta₂O₅ particles on the functionalized carbon supports grown according to embodiments of the present invention with different Ta₂O₅ to carbon ratios. The sample having an absorbance around 0.35 had a Ta₂O₅/carbon ratio of 1.71. The sample having an absorbance around 0.15 had a Ta₂O₅/carbon ratio of 3.42. After direct deposition of Ta₂O₅ particles on the functionalized carbon supports, the carbonyl bands shift for both of the samples despite their different Ta₂O₅ to C ratios. The characteristic absorption bands around 680 cm⁻¹ are due to stretching vibrations of Ta—O bonds. The carbonyl stretching vibrations of the Ta₂O₅/C samples were blue shifted from 1720-1682 cm⁻¹ to 1660-50 cm⁻¹ compared to the carbonyl stretching vibrations prior to synthesis. This is a clear indication of the formation of covalent bonds between the carbon samples and the Ta₂O₅ in both instances.

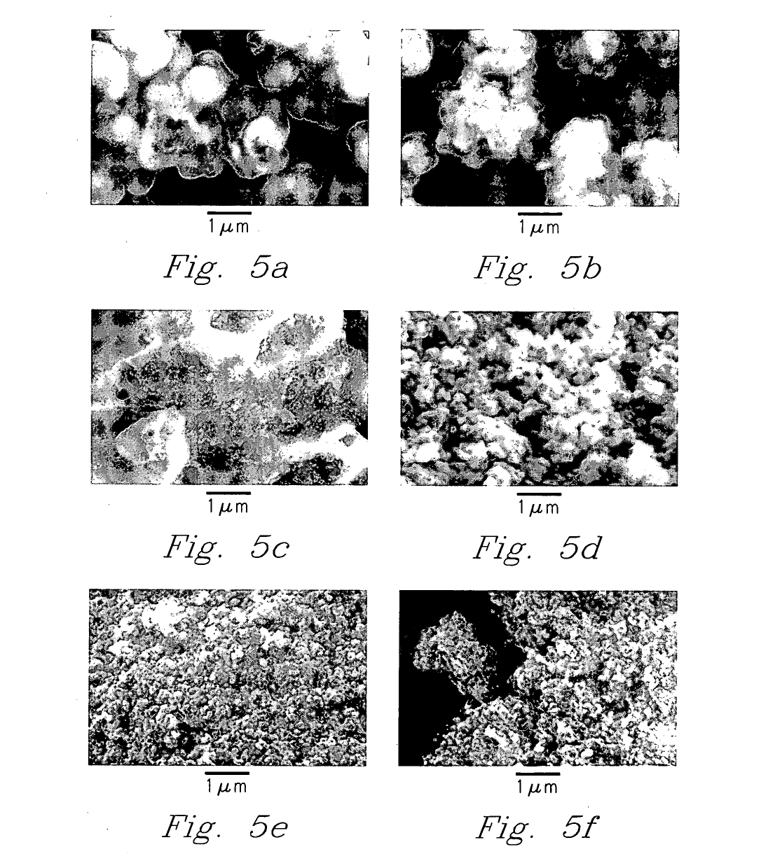

FIG. 5 includes scanning electron graphs of Ta₂O₅/C samples comparing the morphology and size distribution of Ta₂O₅ particles on carbon surfaces. In FIGS. 3a through 3c, the Ta₂O₅ particles are dense, relatively large aggregates. In contrast, FIG. 3d through 3f show Ta₂O₅ particles synthesized with various Ta₂O₅/C ratios on the surfaces of functionalized carbon, revealing that Ta₂O₅ sub-micron particles can be homogeneously distributed. The well-distributed Ta₂O₅ particles deposited onto the functionalized carbon supports according to embodiments of the present invention demonstrate that the acid treatment and the claimed synthesis technique is effective in producing nanoparticles that are well distributed on the carbon surface. This improved morphology results in many active sites (i.e., triple-phase boundaries) on the carbon surface. Accordingly, the direct synthesis processes of the present invention can overcome the problem of particle aggregation, which is common to processes that rely on heating to relatively high temperatures.

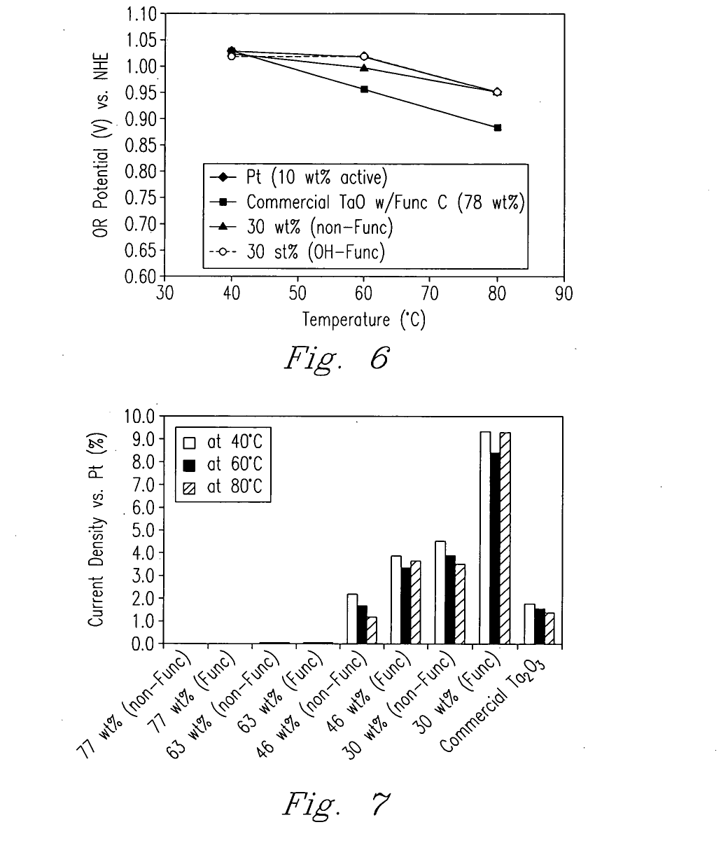

Referring to FIGS. 6 through 8, electrochemical analysis shows that carbon-supported tantalum oxide nanoparticles of the present invention have improved performance compared to commercially-available materials and materials grown using conventional techniques. The electrochemical analysis was conducted using a half cell configuration, where platinum was used as counter electrode, and a saturated calomel electrode was used as a reference electrode. The working electrode was prepared by applying a paste of an active material and nafion (5 wt % in mixture of lower aliphatic alcohols and water) to PTFE-treated carbon paper. Sulfuric acid (0.1 N) was used as an electrolyte. The electrochemical performance was measured by a voltage sweep in the range of 1.2V to 0.2 V vs. NHE (normal hydrogen electrode).

FIG. 6 is a plot of the oxygen reduction onset potential, under which the oxygen reduction can occur, as a function of temperature. The figure includes data for platinum, a commercial tantalum oxide on functionalized carbon, and for two tantalum oxide/carbon composites, synthesized with non-functionalized carbon and functionalized carbon according to embodiments of the present invention. The plot indicates that the oxygen reduction potential of the carbon-supported tantalum oxide catalysts of the present invention outperform commercially available tantalum oxide and compare well to platinum.

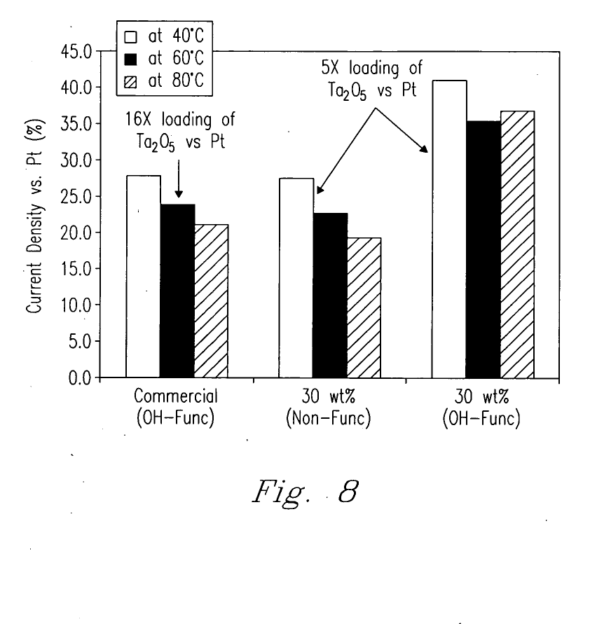

FIG. 7 is a bar graph of the mass specific reduction current density for a variety of samples having different compositions and/or different carbon surface treatments according to embodiments of the present invention. Also included in the graph is the mass specific reduction current density of commercial tantalum oxide. The tantalum oxide based samples are compared to 10 wt % Pt on activated carbon. The bar graph indicates that overall, the tantalum oxide/carbon composites of the present invention prepared with functionalized carbon reveal higher reduction current density than ones synthesized with non-functionalized carbon and those synthesized with commercial tantalum oxide. In addition to the functionalization of carbon providing nucleation sites of tantalum oxide particles on the carbon surface, the synthesis methods of the present invention appears to facilitate the formation of fine tantalum oxide particles uniformly covering the carbon surface, as shown in FIGS. 5d-5f. The current density increases with decrease in the content of tantalum oxide presumably since the finer tantalum oxide particles form on the carbon surface and provide a more open structure for electrochemical reactions. Optimal current densities occurred in the range of 30 wt % to 77 wt % of tantalum oxide. The maximum mass-specific current density, corresponding to ˜9% of that of platinum, was achieved using a composite with 30 wt % tantalum oxide prepared with a functionalized carbon powder.

FIG. 8 is a bar graph of the area specific current density for a variety of samples having different compositions and/or different carbon surface treatments according to embodiments of the present invention. Also included in the graph is the area specific current density of commercial tantalum oxide. The tantalum oxide samples are compared to 10 wt % Pt on activated carbon. With 5 times of active material loading, the tantalum oxide/carbon composite prepared according to the present invention exhibits up to 40% of the area-specific reduction current density of Pt.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for fabricating a hybrid nanocomposite comprising tantalum oxide nanoparticles on a carbon support, the method comprising:
Attaching organic functional groups to the surfaces of a carbon material, resulting in a functionalized carbon support;
Dispersing the functionalized carbon support in an organic liquid;
Forming a mixture by adding a Ta-containing metalorganic precursor to the organic liquid containing the functionalized carbon support, wherein the Ta-containing metalorganic precursor comprises an alkoxide group; and
Reacting the alkoxide groups of the Ta-containing metalorganic precursor with the functional groups on the surface of the functionalized carbon support to form a covalent bond between tantalum oxide nanoparticles and the carbon support.

2. The method of claim 1, wherein the functional group comprises a carboxyl, a carbonyl or a hydroxyl group.

3. The method of claim 1, wherein the organic liquid comprises ethanol.

4. The method of claim 1, wherein the Ta-containing metalorganic precursor comprises tantalum ethoxide.

5. The method of claim 1, wherein the Ta-containing metalorganic precursor is 5% to 75% by weight of the mixture.

6. The method of claim 1, wherein the mixture comprises a volumetric ratio of Ta-containing metalorganic precursor to organic liquid between 1:30 and 1:15.

7. The method of claim 1, further comprising making a complex of the Ta-containing metalorganic precursor prior to forming the mixture.

8. The method of claim 7, wherein the complex comprises a complex between Ta(OEt)₅ and 2,4-acetyl acetonate.

9. The method of claim 1, wherein said reacting comprises hydrolyzing or condensing.

10. The method of claim 1, wherein the tantalum oxide nanoparticles comprise Ta₂O₅.

11. The method of claim 1, wherein the tantalum oxide nanoparticles have diameters less than 1 micron.

12. The method of claim 1, wherein the tantalum oxide nanoparticles have diameters less than or equal to 100 nm.

13. The method of claim 1, wherein no surfactant is added to the mixture.

14. A catalyst for proton exchange membrane (PEM) fuel cells, the catalyst comprising tantalum oxide nanoparticles covalently attached to a carbon support.

15. The catalyst of claim 14, wherein the tantalum oxide nanoparticles comprises Ta₂O₅.

16. The catalyst of claim 14, wherein the tantalum oxide nanoparticles have diameters less than 1 micron.

17. The catalyst of claim 14, wherein the tantalum oxide nanoparticles have diameters less than or equal to 100 nm.

18. The catalyst of claim 14 having a mass specific reduction current greater than 2% of the mass specific reduction current of Pt.

19. The catalyst of claim 14 having an area specific reduction current greater than 30% of the area specific reduction current of Pt.
